(19) United States
(12) Patent Application Publication
(10) Pub. No.: US 2025/0296008 A1
(43) Pub. Date: Sep. 25, 2025

(54) ROBOT AND MANUFACTURING METHOD FOR ROBOT

(71) Applicant: CASIO COMPUTER CO., LTD., Tokyo (JP)

(72) Inventor: Koji YUKI, Tokyo (JP)

(73) Assignee: CASIO COMPUTER CO., LTD., Tokyo (JP)

(21) Appl. No.: 19/087,250

(22) Filed: Mar. 21, 2025

(30) Foreign Application Priority Data
Mar. 22, 2024 (JP) 2024-047301

(51) Int. Cl. A63H 13/00; A63H 9/00

(52) U.S. Cl. CPC A63H 13/005; A63H 9/00; A63H 2200/00

(57) ABSTRACT

A robot includes an exterior; a main body that is covered by the exterior and to which an attachment receiver is provided; a fixing member that is provided on an inner surface of the exterior and at a position fixable to the attachment receiver, a through-hole being formed in the fixing member; and an attachment member for fixing the fixing member to the main body by being attached to the attachment receiver. The attachment receiver is provided more toward one end of the main body, and the fixing member includes a first end that is disposed in a non-fixed state to the inner surface of the exterior and a second end that is fixed to the inner surface of the exterior.

### CROSS-REFERENCE TO RELATED APPLICATIONS

This application claims the benefit of Japanese Patent Application No. 2024-047301, filed on Mar. 22, 2024, the entire disclosure of which is incorporated by reference herein.

### FIELD OF THE INVENTION

The present application relates to a robot and a manufacturing method for a robot.

### BACKGROUND OF THE INVENTION

In, for example, Unexamined Japanese Patent Application Publication No. 2001-191276, a pet robot is disclosed that includes an exterior covers a main body of the robot so as to be detachable, in order to present the robot as a familiar presence such as a pet.

### SUMMARY OF THE INVENTION

A robot according to the present disclosure includes:
an exterior;
a main body that is covered by the exterior and to which an attachment receiver is provided;
a fixing member that is provided on an inner surface of the exterior and at a position fixable to the attachment receiver, a through-hole being formed in the fixing member; and
an attachment member for fixing the fixing member to the main body by being attached to the attachment receiver, wherein
the attachment receiver is provided more toward one end of the main body, and
the fixing member includes a first end that is disposed in a non-fixed state to the inner surface of the exterior and a second end that is fixed to the inner surface of the exterior.

### BRIEF DESCRIPTION OF DRAWINGS

A more complete understanding of this application can be obtained when the following detailed description is considered in conjunction with the following drawings, in which:

FIG. 1 is a perspective view of a robot according to an embodiment of the present disclosure;

FIG. 2 is a perspective view for explaining a main body of the robot according to the embodiment of the present disclosure;

FIG. 3 is a cross-sectional view of the robot according to the embodiment of the present disclosure;

FIG. 4 is a cross-sectional view illustrating a state in which a line fastener is open, according to the embodiment of the present embodiment;

FIG. 5 is a perspective view illustrating positional relationships of plate-shaped members according the embodiment of the present disclosure;

FIG. 6A is an enlarged view of “VI” of FIG. 3;

FIG. 6B is an enlarged view of “VI” of FIG. 4;

FIG. 7 is a back view illustrating the state in which the line fastener is open, according to the embodiment of the present embodiment;

FIG. 8 is a drawing illustrating a plate-shaped member and a thread according to the embodiment of the present disclosure;

FIG. 9 is an enlarged view of “IX” of FIG. 3;

FIG. 10A is drawing illustrating the plate-shaped member and a protrusion-shaped part according to the embodiment of the present disclosure, and is a perspective view of a state in which the plate-shaped member and the protrusion-shaped part are not engaged with each other;

FIG. 10B is drawing illustrating the plate-shaped member and the protrusion-shaped part according to the embodiment of the present disclosure, and is a perspective view of a state in which the plate-shaped member and the protrusion-shaped part are engaged with each other;

FIG. 11A is a perspective view illustrating an attachment method of the plate-shaped member according to the embodiment of the present disclosure;

FIG. 11B is a perspective view illustrating the attachment method of the plate-shaped member according to the embodiment of the present disclosure;

FIG. 11C is a perspective view illustrating the attachment method of the plate-shaped member according to the embodiment of the present disclosure;

FIG. 12 is a drawing focused on “XI” of FIG. 3, and is a cross-sectional view of when a protrusion and an insertion hole are in a non-engaged state; and

FIG. 13 is a flowchart illustrating a manufacturing method for the robot according to the embodiment of the present disclosure.

### DETAILED DESCRIPTION OF THE INVENTION

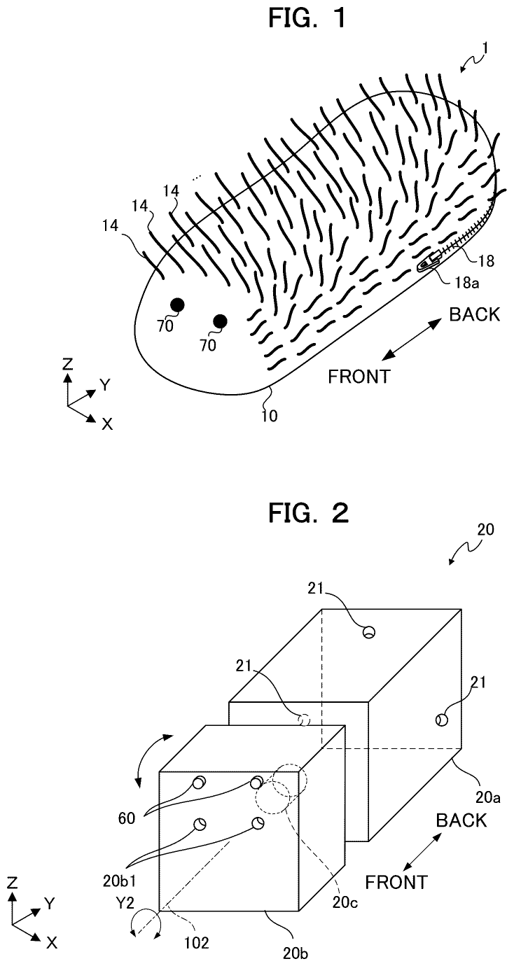

Hereinafter, embodiments of the present disclosure are described while referencing the drawings. Note that, in order to facilitate comprehension of the embodiments, XYZ coordinates that are orthogonal to each other are set and appropriately referenced. In FIG. 1, the front-back direction is defined as the “Y-axis direction.” The front direction is the “−Y-axis direction” and the back direction is the “+Y-axis direction.”

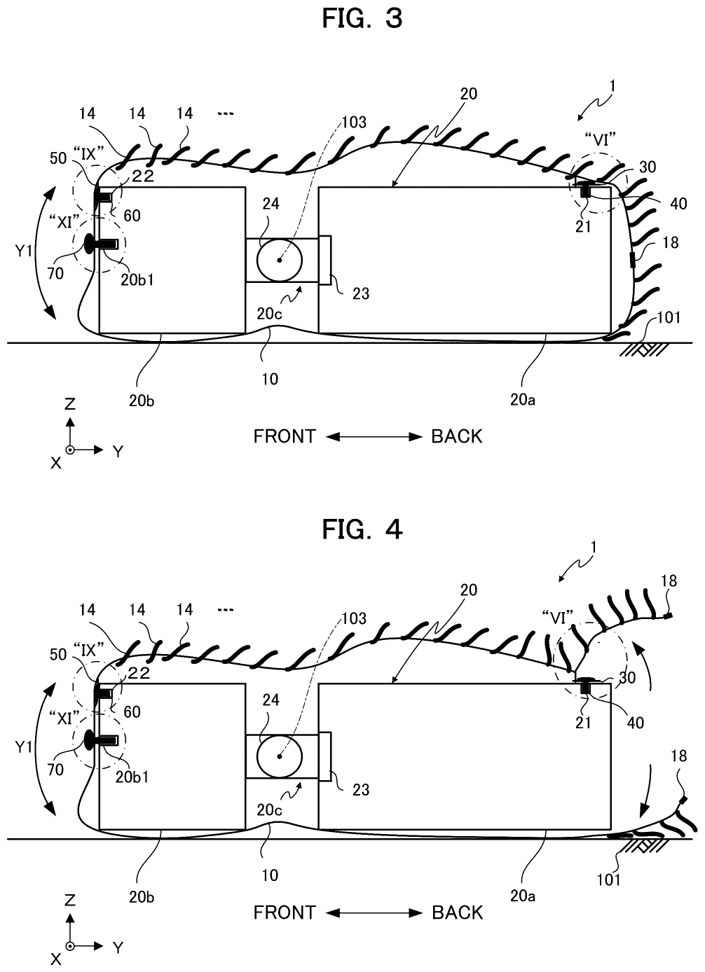

As illustrated in FIGS. 1 and 2, a robot 1 according to an embodiment is a pet robot that resembles a small animal. Two decoration parts 70, each including a decoration resembling the eye of the small animal, are provided on the front side of the robot 1. Thus, a face portion of the small animal is formed on the front side of the robot 1. As illustrated in FIGS. 3 and 4, the robot 1 includes an exterior 10, a main body 20 covered by the exterior 10, a plate-shaped member 30 (fixing member), a screw 40 (attacher), a plate-shaped member 50 (other side fixing member), and a protrusion-shaped part 60 (other side attachment member).

As illustrated in FIGS. 2 to 4, the main body 20 includes a torso 20a, a head 20b provided on a front of the torso 20a, and a coupler 20c that couples the torso 20a and the head 20b. In one example, the main body 20 is made from a synthetic resin, and is colored light pink so as not to give a mechanical impression to a user.

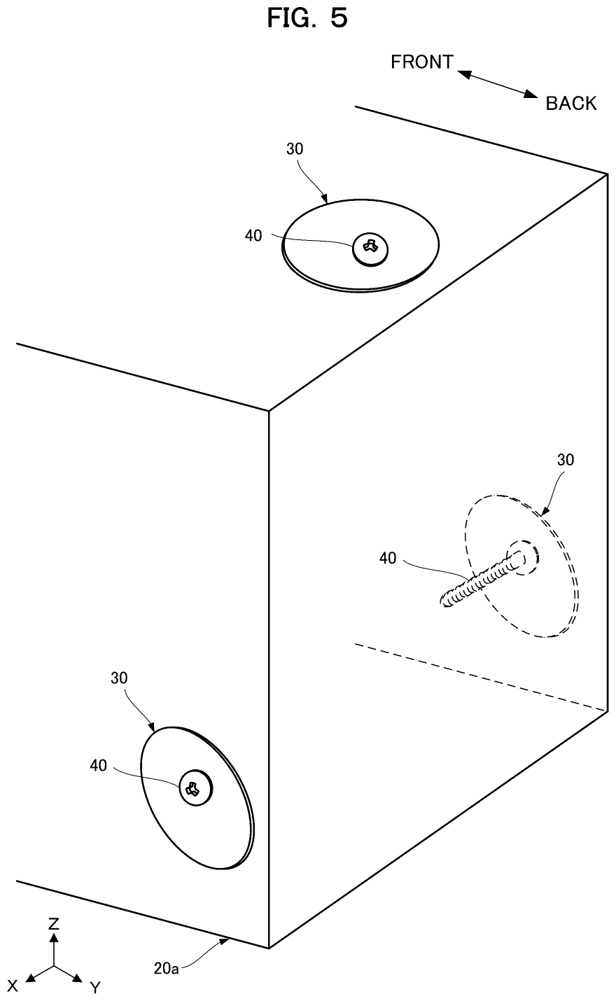

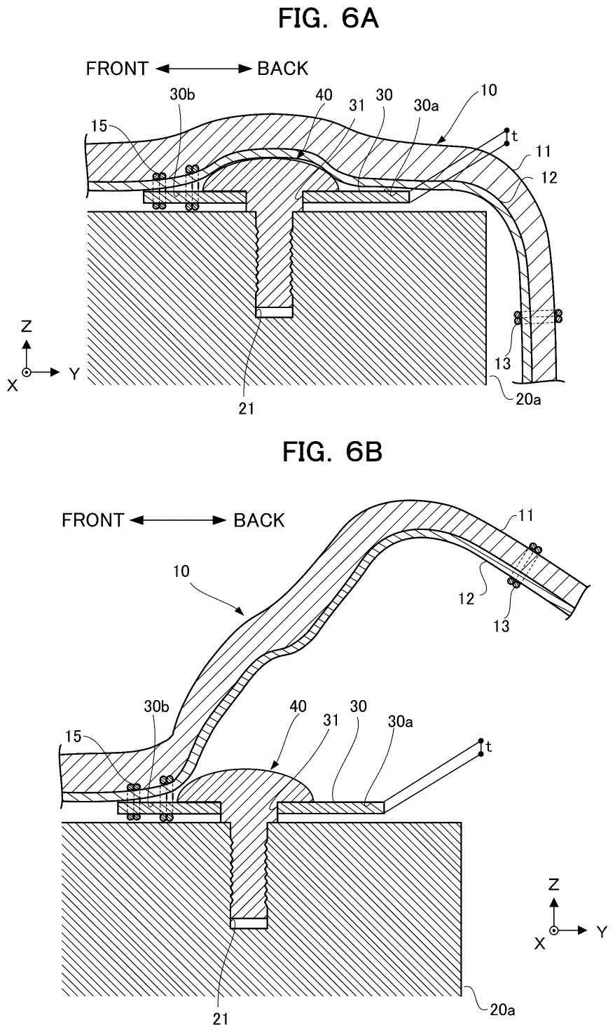

The torso 20a has a shape that is long in the front-back direction, and is placed on a placement surface 101 such floor, a table, or the like with the exterior 10 therebetween. Three screw holes 21 (attachment receiver) are formed in the torso 20a. As illustrated in FIGS. 5, 6A, and 6B, the screw holes 21 are formed more to one end (the end on the +Y side) of the torso 20a. The plate-shaped member 30 that is a fixing member provided on the exterior 10 (see FIG. 3) and each of the screw holes 21 formed in the torso 20a are engaged by the screw 40 that is a Y-pin, which is a special pin and, as a result, the exterior 10 can be caused to move together with the movement of the main body 20 (see FIG. 3). A label that indicates a serial number, a rating, or a certification standard as individual information is attached at the back of the torso 20a. A power button is provided at the back of the torso 20a.

As illustrated in FIGS. 1 to 3, the head 20b is a part that corresponds to the head of the robot 1 that resembles a small animal. Two insertion holes 20b1 are formed at the front of the head 20b. decoration parts 70, each resembling the eye of the small animal are inserted into the insertion holes 20b1. Additionally, two protrusion-shaped parts 60 that each engage with a plate-shaped member 50 provided to the exterior 10 are attached above the two insertion holes 20b1 so as to correspond with the insertion holes 20b1. By engaging the plate-shaped member 50 provided to the exterior 10 with the protrusion-shaped parts 60 attached to the head 20b, the exterior 10 can be caused to move together with the movement of the main body 20. Note that details of the plate-shaped member 50, the protrusion-shaped parts 60, and the decoration parts 70 are described later.

The coupler 20c couples a back end of the head 20b to a front end of the torso 20a. A twist motor 23 and a vertical motor 24 are provided in the coupler 20c. As illustrated in FIG. 2, the twist motor 23 rotates the head 20b in the direction of arrow Y2 around an axis 102 extending in the front-back direction. By causing the head 20b to move in this manner, it is possible to cause the robot 1, illustrated in FIG. 1, that resembles a small animal to perform a gesture of tilting the head. As illustrated in FIG. 3, the vertical motor 24 rotates the head 20b in the direction illustrated as arrow Y1 around an axis 103 parallel to the X-axis direction. By the head 20b to move in this manner, it is possible to cause the robot 1, illustrated in FIG. 1, that resembles a small animal to perform a gesture of shaking the head up and down. Thus, the coupler 20c couples the head 20b to the torso 20a such that the head 20b is capable of movement on two axes, namely rotation by the twist motor 23 and rotation by the vertical motor 24.

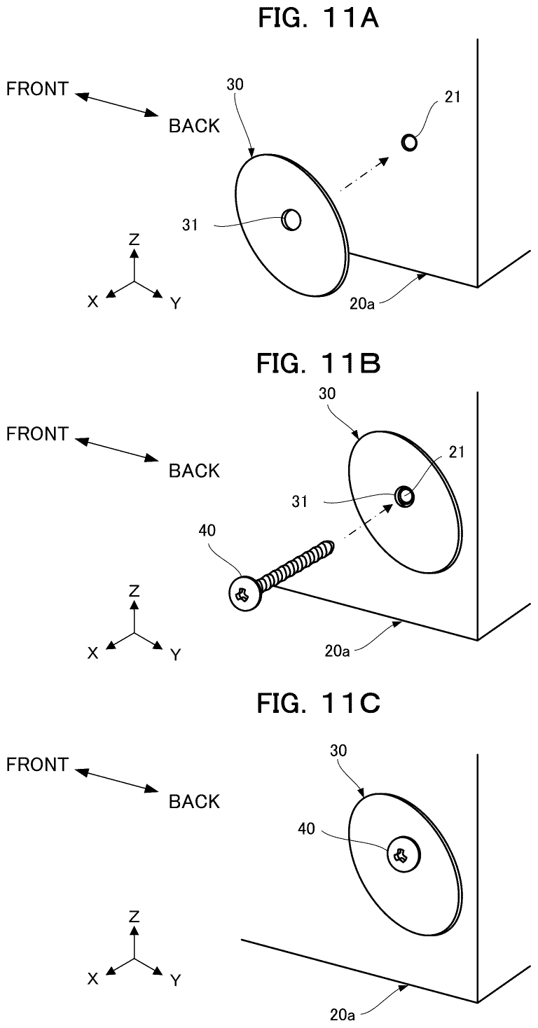

As illustrated in FIG. 1, the exterior 10 has the shape of a bag that is long in the front-back direction, has an opening formed in a back portion thereof, and is capable of accommodating the main body 20 therein (see FIG. 3). As illustrated in FIGS. 6A and 6B, the exterior 10 is formed by sewing a sheet-like outer fabric 11 and a lining 12 together using thread 13 at plurality of locations, in a state in which the outer fabric 11 and the lining 12 are stacked on each other. By sewing the outer fabric 11 and the lining 12 together using the thread 13 at the plurality of locations in this manner, the outer fabric 11 and the lining 12 can be integrally handled without misalignments occurring therebetween. As illustrated in FIGS. 1 and 3, the outer fabric 11 is formed from an artificial pile fabric that resembles fur 14 of a small animal. Due to this, the tactile sensation of the robot 1 can be made to resemble that of a small animal. Note that the fur 14 illustrated in FIGS. 1 and 3 is omitted from FIGS. 6A and 6B, and the hereinafter described FIGS. 9, 11A, 11B, and 11C in order to prevent complication of the drawings. The lining 12 is formed from a woven fabric obtained by weaving synthetic fibers. Alternatively, the lining 12 may be formed from natural leather, artificial leather, a sheet material made of synthetic resin, a sheet material made of rubber, or a fabric made of natural fibers. Moreover, as illustrated in FIGS. 3 and 4, the plate-shaped members 30, 50 are provided on an inner side of the exterior 10.

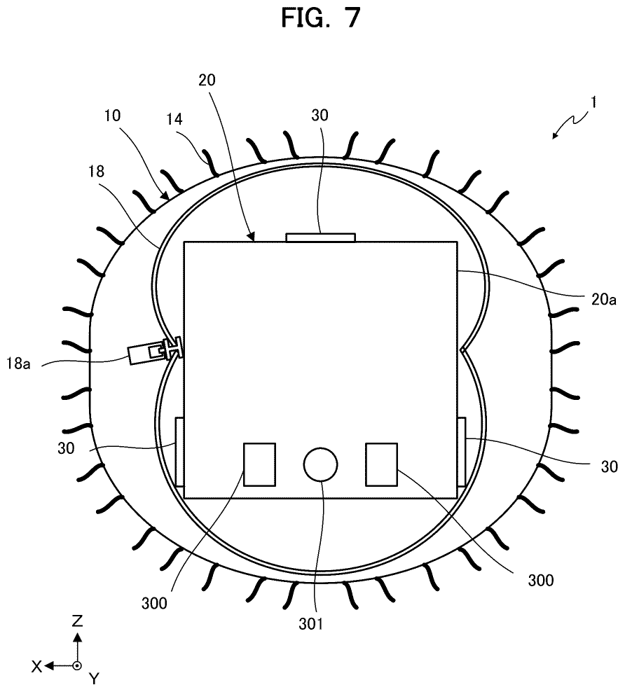

As illustrated in FIGS. 1 and 3, a line fastener 18 (fastener) is attached to the back of the exterior 10 as a fastener capable of opening and closing the opening of the exterior 10. By sliding a slider 18a to a closed state while the main body 20 is accommodated in the exterior 10, a state in which the main body 20 is accommodated is maintained. Meanwhile, by sliding the slider 18a to a state in which the line fastener 18 is open, an opening is formed and it is possible to remove the main body 20 accommodated therein, insert the main body 20 into the exterior 10, and the like. As illustrated in FIGS. 4 and 7, by setting the line fastener 18 to the open state, it is possible to pull the exterior 10 away and remove a portion of the exterior 10 from the main body 20. A label 300 expressing product information and a power button 301 are provided at positions that are exposed to the outside through the opening, at the opening formed by opening the line fastener 18 and removing the portion of the exterior 10 from the main body 20.

As illustrated in FIGS. 2 and 3, the exterior 10 is caused to move in accordance with the movement of the main body 20 resulting from the driving of the twist motor 23 and the vertical motor 24 and, as such, the robot 1 that resembles a small animal can be caused to move as if alive. In order to realize this, the exterior 10 is appropriately latched to the main body 20 using the decoration parts 70, the plate-shaped members 50 and the insertion holes 20b1, and the protrusion-shaped parts 60 and, as a result, the exterior 10 is caused to conform to the movement of the main body 20. Furthermore, the exterior 10 is appropriately latched to the main body 20 by inserting the screw 40 into the through-hole 31 of each of the plate-shaped members 30 and also fitting the screw 40 into each of the screw holes 21 of the torso 20a and, as a result, the exterior 10 is caused to conform to the movement of the main body 20. Next, the configuration of latching the exterior 10 to the main body 20 accommodated in the exterior 10 is described in detail. Note that the three screw holes 21 provided in the main body 20 illustrated in FIGS. 2 and 3 all have the same configuration, the two protrusion-shaped parts 60 provided to the main body 20 have the same configuration, and the three plate-shaped members 30 and the two plate-shaped members 50 provided to the exterior 10 all have the same configuration. As such, in the following, the configurations of the protrusion-shaped part 60 and the plate-shaped member 50 of “IX”, and the screw hole 21 and the plate-shaped member 30 of “VI” of FIGS. 3 and 4 are described.

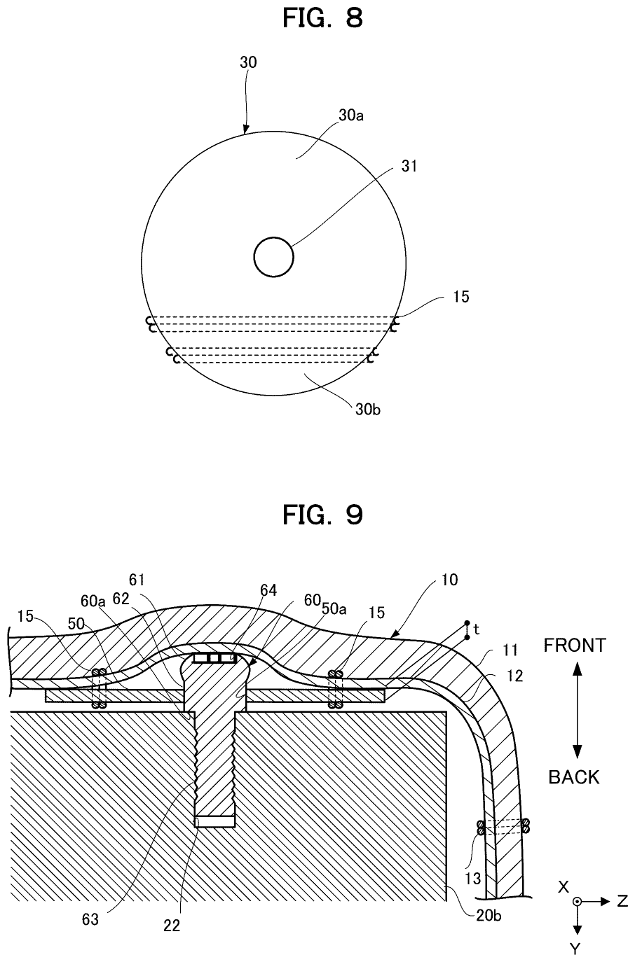

As illustrated in FIG. 3, the plate-shaped member 30 is a snap provided, on the inner surface of the exterior 10, at a position capable of being fixed to the screw hole 21. Likewise, the plate-shaped member 50 is a snap provided, on the inner surface of the exterior 10, at a position capable of being fixed to the insertion hole 20b1. Specifically, the plate-shaped member 30 that serves as a fixing member and the plate-shaped member 50 that serves as an other side fixing member are sewn to the inner side of the exterior 10. The plate-shaped members 30, 50 are, for example, made from polyamide 6 (PA6) having a thickness t of 0.5 mm. As illustrated in FIGS. 8 to 10A and 10B, the plate-shaped members 30, 50 are molded in a disk shape. In one example, the diameter of the plate-shaped members 30, 50 is 16 mm. Additionally, the through-hole 31 through which the screw 40 is inserted is formed at a center of the plate-shaped member 30. Moreover, a round hole 50a (other side through-hole), that serves as a fitting hole in which the protrusion-shaped part 60 is inserted and fitted, is formed at a center of the plate-shaped member 50. As illustrated in FIGS. 6A, 6B, and 9, the plate-shaped members 30, 50 are sewn to only the lining 12 of the exterior 10 using the thread 15, and are not sewn to the outer fabric 11. The sewing of the plate-shaped members 30, 50 to the lining 12 is performed before the lining 12 and the outer fabric 11 are sewn to each other. As described above, the plate-shaped members 30, 50 are disk-shaped and do not have steps, and the thickness t of the plate-shaped members 30, 50 are 0.5 mm. As such, large steps that cause problems when sewing the plate-shaped members 30, 50 to the lining 12 using a sewing machine are not formed between the plate-shaped members 30, 50 and the lining 12. As such, the sewing of the plate-shaped members 30, 50 is performed using a sewing machine to ensure ease of work.

The sewing of the plate-shaped member 30 to the lining 12 is performed such that, for example, as illustrated in FIGS. 6A, 6B, and 8, one end 30a of the plate-shaped member 30 is disposed in a non-fixed state to the inner surface of the exterior 10 and the other end 30b is fixed to the inner surface of the exterior 10. The through-hole 31 of the plate-shaped member 30 is formed between the one end 30a and the other end 30b of the plate-shaped member 30.

As illustrated in FIG. 5, three screw holes 21 are formed in the torso 20a. The screw holes 21 are formed in a top surface and both side surfaces (X-axis direction side surfaces) at the back of the torso 20a. Furthermore, the plate-shaped member 30 provided on the exterior 10 (see FIG. 3) is fixed to the torso 20a by the screw 40 being inserted into the through-hole 31 of the plate-shaped member 30 and then being screwed into the screw hole 21 of the torso 20a.

The diameter of the through-hole 31 formed in the plate-shaped member 30 is larger than the diameter of the threads of the screw 40, and is smaller than the diameter of the head of the screw 40 in which a Y-shaped groove is formed. The diameter of the through-hole 31 is of a size whereby the head of the screw 40 does not fall out of the through-hole 31 even if the plate-shaped member 30 deforms. When fixing the plate-shaped member 30 to the torso 20a, as illustrated in FIG. 11A, the plate-shaped member 30 is pressed against the torso 20a, and the through-hole 31 of the plate-shaped member 30 and the screw hole 21 of the torso 20a are aligned. Next, as illustrated in FIG. 11B, the screw 40 is inserted into the through-hole 31 of the plate-shaped member 30, and then screwed into the screw hole 21 of the torso 20a. Then, as illustrated in FIG. 11C, the head of the screw 40 is pressed against the plate-shaped member 30. Thus, the work of engaging the plate-shaped member 30 with the torso 20a is completed. The plate-shaped member 30 is fixed to the torso 20a by the head of the screw 40. As such, as long as work to remove the screw 40 is not performed with clear intent such as to remove the plate-shaped member 30 from the torso 20a, the plate-shaped member 30 does not easily separate from the torso 20a. Furthermore, the screw 40 is a Y-pin and cannot be removed without using a specialized screwdriver.

As illustrated in FIG. 2, three of the screw holes 21 are formed in the torso 20a of the main body 20. As illustrated in FIG. 3, the plate-shaped member 30 is sewn to the exterior 10, covering the main body 20, at positions corresponding to each screw hole 21. That is, the attaching of the exterior 10 to the main body 20 is performed using the plate-shaped member 30 and the screw hole 21 at a total of three locations. By performing the attaching of the exterior 10 at a plurality of locations in this manner, the exterior 10 can be made to conform to the movement of the main body 20, and the robot that resembles a small animal can be made to perform gestures as if alive.

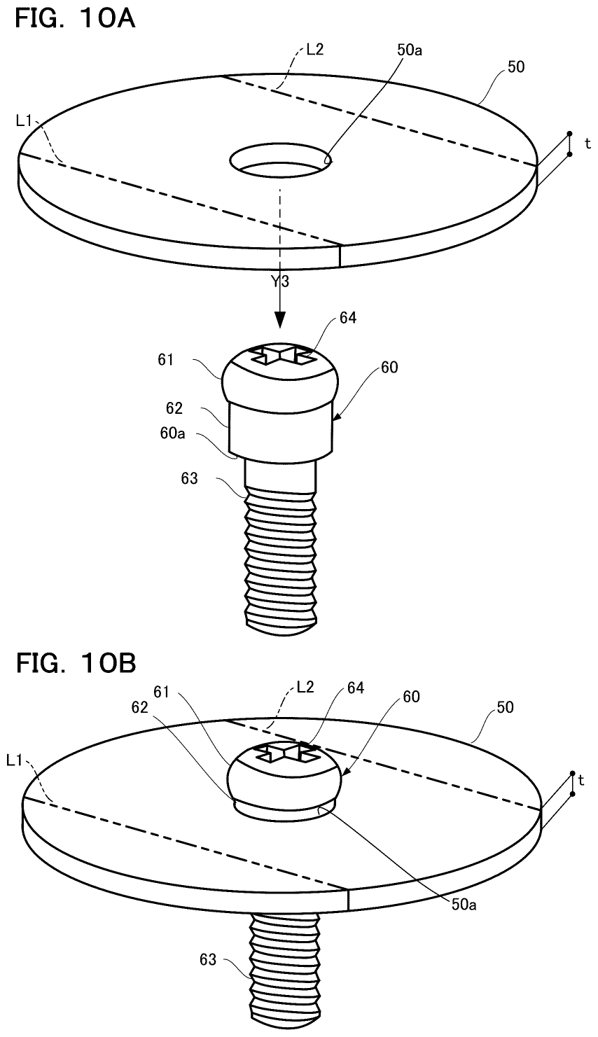

In one example, as illustrated in FIG. 10A, the sewing of the plate-shaped member 50 to the lining 12 is performed along two straight and parallel lines L1, L2 between which the round hole 50a is positioned. As described above, the diameter of the plate-shaped member 50 is set to 16 mm and, as such, it is possible to secure a sewing distance needed to ensure the sewing strength of the plate-shaped member 50. Here, the term “sewing distance” is the length of the portion of the plate-shaped member 50 sewn using the thread 15, that is, is the total of the lengths of the lines L1, L2.

As illustrated in FIG. 9, the protrusion-shaped part 60 that engages with the plate-shaped member 50 is attached to the torso 20a that constitutes a portion of the main body 20. As illustrated in FIG. 10A, the protrusion-shaped part 60 includes a head 61 on which a plus-symbol groove 64 is formed, a cylindrical spacer 62, and a shaft 63 in which male threads are cut. As illustrated in FIG. 9, an insertion hole 22, that serves as an other side attachment receiver, in which female threads are cut that mate with the male threads of the shaft 63, is formed in the torso 20a. The head 61 is a large diameter portion that has the largest diameter in the protrusion-shaped part 60. The spacer 62 sandwiched between the head 61 and the shaft 63 is a small diameter portion that has a diameter smaller than that of the head 61 and larger than that of the insertion hole 22. As such, when the protrusion-shaped part 60 is screwed into the insertion hole 22 using a screwdriver, a lower end 62a of the spacer 62 illustrated in FIG. 10A eventually contacts the torso 20a, thereby preventing the protrusion-shaped part 60 from being screwed in any further. Thus, the attaching of the protrusion-shaped part 60 to the torso 20a is completed by screwing the protrusion-shaped part 60 into the torso 20a until the lower end 62a of the spacer 62 contacts the torso 20a. As illustrated in FIG. 9, the attached protrusion-shaped part 60 protrudes from the torso 20a by a height equal to the sum of the height of the head 61 and the height of the spacer 62. Note that, as illustrated in FIGS. 9 and 10B, the head 61 has a bulging shape whereby the diameter is smallest at both end portions in the longitudinal direction of the protrusion-shaped part 60, and is greatest at a center portion in the longitudinal direction. Moreover, the diameter of the portion of the head 61 connecting to the spacer 62 is equal to that of the cylindrical spacer 62.

Note that the diameter of the round hole 50a formed in the plate-shaped member 50 is about 0.2 mm smaller than the diameter of the spacer 62 of the protrusion-shaped part 60. When engaging the plate-shaped member 50, having this round hole 50a formed therein, with the protrusion-shaped part 60, firstly, as illustrated by arrow Y3 of FIG. 10A, the plate-shaped member 50 is brought near to the protrusion-shaped part 60. Then, the round hole 50a formed in the plate-shaped member 50 is pressed against and passed over the head 61, which is the large diameter portion. Then, as illustrated in FIG. 10B, the round hole 50a is fitted on the spacer 62, which is the small diameter part. The plate-shaped member 50 is formed from a material that has a small amount of elasticity and, as such, the round hole 50a can pass over the head 61, which is the large diameter portion. As illustrated in FIGS. 9 and 10B, the round hole 50a of the plate-shaped member 50 that has passed over the head 61 is fitted on the spacer 62 that has a diameter larger than the diameter of the round hole 50a. Thus, the work of engaging the plate-shaped member 50 with the protrusion-shaped part 60 is completed. Thus, the round hole 50a of the plate-shaped member 50 is in a state fitted to the spacer 62 of the protrusion-shaped part 60 without a gap and, furthermore, the head 61, which is the large diameter portion, is disposed above the round hole 50a. As a result, the engaged state of the plate-shaped member 50 and the protrusion-shaped part 60 can be made strong and, as long as work to remove the plate-shaped member 50 and the protrusion-shaped part 60 is performed with clear intent such as disengaging the engaged state, the engaged state of the plate-shaped member 50 and the protrusion-shaped part 60 is not easily disengaged.

As illustrated in FIG. 2, two of the protrusion-shaped part 60 are provided on the head 20b of the main body 20. As illustrated in FIG. 3, the plate-shaped member 50 is sewn to the exterior 10, covering the main body 20, at positions corresponding to each protrusion-shaped part 60. That is, the attaching of the exterior 10 to the main body 20 is performed using the plate-shaped member 50 and the protrusion-shaped part 60 at a total of two locations. By performing the attaching of the exterior 10 at a plurality of locations in this manner, the exterior 10 can be made to conform to the movement of the main body 20, and the robot 1 that resembles a small animal can be made to perform gestures as if alive.

As illustrated in FIG. 3, with the robot 1, by inserting the decoration parts 70 resembling the eyes of a small animal into the insertion holes 20b1 formed in the head 20b, the exterior 10 can be latched to the main body 20 and general positioning of both of the decoration parts 70 can be carried out. The decoration parts 70 are formed from black synthetic resin, for example, to match the color of the eyes of a small animal. Each of the decoration parts 70 includes a semi-spherical decoration 70a, and a protrusion 70b that extends from the decoration 70a and protrudes from an inner side of the exterior 10. A through-hole 16 for allowing the protrusion 70b to pass through is formed in the exterior 10. Each of the decoration parts 70 is configured so that the decoration 70a is positioned on the outer fabric 11 side and the protrusion 70b is inserted into the through-hole 16. As a result, each decoration 70a is provided in a state exposed to the outside of the exterior 10, and decorates the exterior 10 as a part resembling the eye of a small animal. Additionally, a washer 17 is fitted on the protrusion 70b that penetrates the exterior 10 and protrudes from the inside. The washer 17 includes a claw 17a that hooks on the threads of the protrusion 70b. As a result, the decoration parts 70 can be prevented from falling out of the exterior 10.

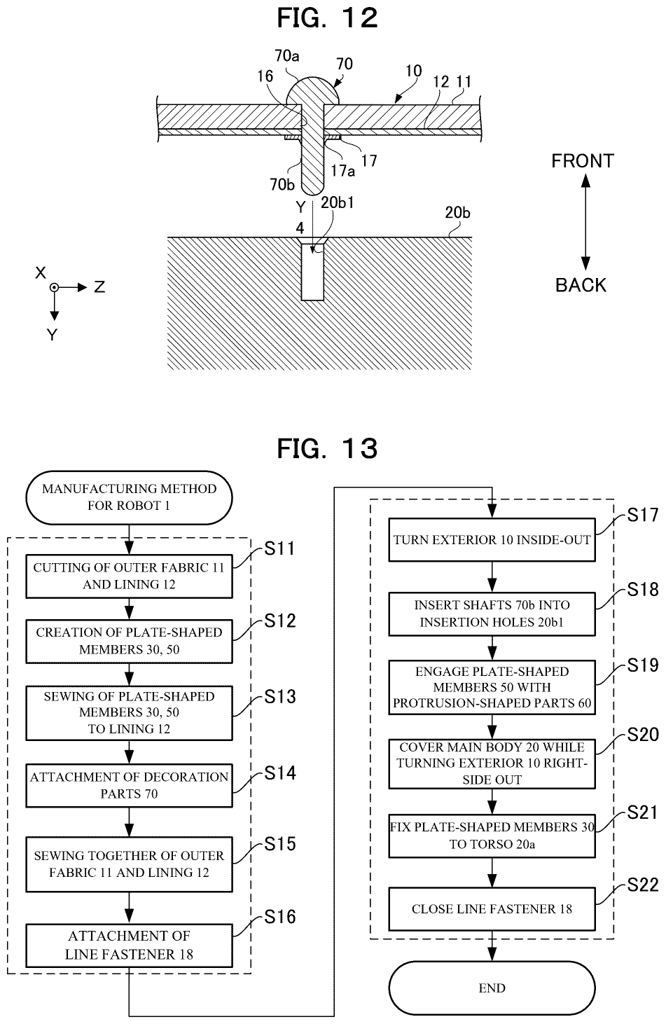

Meanwhile, as illustrated in FIG. 12, the insertion hole 20b1 into which the protrusion 70b of the decoration part 70 is inserted is formed in the head 20b that constitutes a portion of the main body 20. Due to this, the protrusion 70b is inserted into and engages with the insertion hole 20b1. The diameter of the insertion hole 20b1 is the same as or slightly larger than the diameter of the protrusion 70b. Due to this, the protrusion 70b can be easily inserted into and removed from the insertion hole 20b1. By inserting the protrusion 70b into the insertion hole 20b1 , the exterior 10 can be latched onto the main body 20, and misalignment between the exterior 10 and the main body 20 can be prevented from occurring when attaching/detaching the exterior 10. Moreover, the exterior 10 and the main body 20 can be positioned, and it is possible to prevent situations such as the positional relationship between the exterior 10 and the main body 20 being lost during the attaching/detaching of the exterior 10. This facilitates the work of attaching/detaching the exterior 10.

Next, a manufacturing method for the robot 1 is described while referencing FIG. 13. Firstly, fabric for forming the outer fabric 11 and fabric for forming the lining 12 of the exterior 10 are cut to predetermined shapes (step S11). Next, a polyamide 6 (PA6) plate having a thickness t of 0.5 mm is punched in a circular shape and, as illustrated in FIGS. 8 and 10A, the through-hole 31 through which the screw 40 is inserted is formed or the round hole 50a through which the protrusion-shaped part 60 is inserted is formed in the center to create three plate-shaped members 30 and two plate-shaped members 50 (step S12). Next, using a sewing machine, the created plate-shaped members 30 are respectively sewn to three predetermined locations of the lining 12, and the created plate-shaped members 50 are respectively sewn to two predetermined locations of the lining 12 (step S13). The sewing of the plate-shaped members 30 in step S13 is executed by causing the sewing needle to penetrate the plate-shaped member 30 and pass the thread 15 (see FIG. 6) through the plate-shaped members 30 and the lining 12, and the sewing of the plate-shaped members 50 is executed by causing the sewing needle to penetrate the plate-shaped members 50 and pass the thread 15 (see FIG. 9) through the plate-shaped members 50 and the lining 12. Note that the sewn location of the plate-shaped members 30 is the one end 30a of the plate-shaped member 30, as illustrated in FIG. 8. Moreover, the sewn locations of the plate-shaped members 50 are, as illustrated in FIGS. 10A and 10B, on the two straight and parallel lines L1, L2 between which the round hole 50a is positioned. Next, the outer fabric 11 and the lining 12 are stacked on each other, the two through-holes 16 illustrated in FIG. 12 that penetrate the outer fabric 11 and the lining 12 are formed, and the decoration parts 70 are attached to the through-holes 16 (step S14). The attaching of the decoration parts 70 is carried out by inserting the protrusion 70b of each of the decoration parts 70 into each of the through-holes 16 with the decorations 70a positioned on the outer fabric 11 side, and fitting the washer 17 onto the protrusions 70b protruding from the lining 12. Next, the outer fabric 11 and the lining 12 are sewn together to form a bag shape (step S15). Lastly, the line fastener 18 illustrated in FIG. 1 is attached (step S16). Thus, the creation of the exterior 10 is completed. The exterior 10 can be created by executing steps S11 to S16 in this manner.

Next, the created exterior 10 is attached to the main body 20. Firstly, the line fastener 18 illustrated in FIG. 1 is opened and the exterior 10 is turned inside-out so that the outside fur 14 is on the inside (step S17). Doing this makes it possible to easily view the protrusions 70b of the decoration parts 70 protruding from the lining 12 (see FIGS. 11A, 11B, and 11C) and the plate-shaped members 30, 50 sewn to the lining 12 (see FIGS. 6A, 6B, and 9). Next, the portion of the exterior 10 where the decoration parts 70 are attached is turned right-side out, and the two protrusions 70b protruding from the lining 12 are inserted into the corresponding insertion holes 20b1 illustrated in FIG. 2 (step S18). As a result, the protrusions 70b protruding from the exterior 10 can be aligned with the insertion holes 20b1 formed in the head 20b, and the exterior 10 and the main body 20 can be roughly positioned. Additionally, by inserting the protruding protrusions 70b into the insertion holes 20b1, the exterior 10 can be latched onto the main body 20 from the positioned state, and misalignments between the exterior 10 and the main body 20 can be prevented. Note that when the exterior 10 is turned right-side out, it is no longer possible to view the protrusions 70b. However, the protrusions 70b are parts that protrude from the decorations 70a and, as such, provided that the decorations 70a that are on the outside can be seen, it is possible to recognize the protrusions 70b. As such, even when the exterior 10 is turned right-side out, the protrusions 70b can easily be inserted into the insertion holes 20b1.

Next, the plate-shaped members 50 provided near the decoration parts 70 (in FIG. 3, the plate-shaped members 50 disposed directly above the decoration parts 70) are engaged with the protrusion-shaped parts 60 serving as first engagement receivers provided on the head 20b (step S19). To engage the plate-shaped members 50 with the protrusion-shaped parts 60, firstly, the round hole 50a formed in each plate-shaped member 50 is pressed against and passed over the head 61, which is the large diameter portion. Next, as illustrated in FIG. 10B, the round hole 50a is fitted on the spacer 62, which is the small diameter part. Thus, the plate-shaped members 50 are engaged with the protrusion-shaped parts 60.

Next, the main body 20 is sequentially covered with the exterior 10 from the front side toward the back side while turning the inside-out exterior 10 right-side out (step S20). Next, the plate-shaped member 50 serving as the other side fixing member provided on the back end of the exterior 10 illustrated in FIG. 3 is engaged with the protrusion-shaped part 60 serving as the other side attachment member provided on the back end of the torso 20a (step S21). Next, the main body 20 is entirely covered with the exterior 10 and, finally, the line fastener 18 is closed (step S22). The exterior 10 is attached to the main body 20, and the robot 1 is manufactured by executing steps S17 to S22 in this manner.

As described above, the exterior 10 is made from a fabric and, as such, gradually becomes soiled as the robot 1 is used. As such, attachment/detachment work of the exterior 10 is performed in order to wash the exterior 10. Note that, for the method of removing the exterior 10, it is sufficient to reverse the order of attaching the exterior 10 described above. By attaching the washed exterior 10 to the main body 20 in accordance with the procedures described above, a clean robot 1 can be used. As such, a robot 1 can be realized that has improved ease of handling compared to conventional robots.

As described above, with the robot 1 according to the present embodiment, as illustrated in FIGS. 6A and 6B, one end 30a of the plate-shaped member 30 is disposed in a non-fixed state to the inner surface of the exterior 10 and the other end 30b is fixed to the inner surface of the exterior 10. Therefore, as illustrated in FIG. 4, when a portion of the exterior 10 is pulled away from the main body 20, it is possible to expose, to outside, the screws 40 screwed into the screw holes 21. As a result, a robot 1 can be provided that has improved ease of handling.

In the present embodiment, as illustrated in FIGS. 6A and 6B, the through-hole 31 is formed between the one end 30a and the other end 30b of the plate-shaped member 30. That is, in the plate-shaped member 30, the one end 30a is formed on one side of the through-hole 31, and the other end 30b is formed on the opposite side of the through-hole 31. Therefore, as illustrated in FIG. 4, when a portion of the exterior 10 is pulled away from the main body 20, it is possible to make it easier to expose, to outside, the screws 40 screwed into the screw holes 21. As a result, a robot 1 can be provided that has improved ease of handling.

In the present embodiment, as illustrated in FIGS. 2 and 3, the three screw holes 21 are formed more to one end of the main body 20 (the +Y side of the main body 20), and the plate-shaped members 30 are attached to the screw holes 21 by the screws 40. The two insertion holes 22 are formed more to the other end of the main body 20 (the −Y side of the main body 20 that is opposite the +Y side), and the plate-shaped members 50 are attached to the insertion holes 22 by the protrusion-shaped parts 60. Due to this, the plate-shaped members 30, 50 can be disposed in a well-balanced manner. This makes it possible to efficiently transfer the movement of the main body 20 to the exterior 10.

In the present embodiment, as illustrated in FIG. 5, the screws 40 are Y-pins, which are special screws. As such, the user cannot rotate the screws 40 with a general tool such as a Phillips screwdriver or a flathead screwdriver. Consequently, it is difficult for the user to unintentionally remove the exterior 10 from the main body 20. Moreover, it is difficult for the user to remove the exterior 10 from the main body 20 and expose the drive components of the main body 20. As a result, a robot 1 can be provided that has improved ease of handling.

In the present embodiment, as illustrated in FIGS. 3 and 4, in the exterior 10, the opening is formed that is provided with the openable/closeable line fastener 18 and that exposes the one end of the main body 20 and the screws 40 that are screwed into the screw holes 21. As such, as illustrated in FIG. 7, the user can view the label 300 and the power button 301 by opening the line fastener 18.

According to the embodiment described above, the plate-shaped members 30, 50 are provided on the inner side of the exterior 10. As a result, the plate-shaped members 30, 50 cannot be seen by the user and do not obstruct the design of the robot 1. Moreover, the plate-shaped members 30, 50 are not sewn to the outer fabric 11 but are only sewn to the lining 12. Due to this, the thread 15 for sewing the plate-shaped members 30, 50 does not appear on the outer surface of the robot 1 and does not obstruct the design of the robot 1. As such, a robot 1 can be realized that has higher design compared to conventional robots.

When the exterior 10 deforms, the plate-shaped members 30, 50 that have elasticity deform similarly without resisting and, as such, it is possible to prevent the application of an excessive force to the attaching means of the plate-shaped members 30, 50 (in the present embodiment, the thread 15 illustrated in FIGS. 6A, 6B, and 9), and it is possible to prevent damage to the exterior 10, breakage of the attaching means, and unintentional detachment of the plate-shaped members 30, 50 from the exterior 10.

The thickness t of the plate-shaped members 30, 50 is set to 0.5 mm and, as such, when sewing using a sewing machine, large steps that cause problems are not formed between the plate-shaped members 30, 50 and the lining 12. Additionally, the plate-shaped members 30, 50 are formed in flat plate shapes and do not have unevennesses and, as such, the plate-shaped members 30, 50 can be directly sewed using a sewing machine on the plate-shaped members 30, 50. As a result, work efficiency can be improved. Moreover, the sewing accuracy and the sewing strength can be made uniform, and improvements in quality can be obtained. Furthermore, the need to form holes, for passing the thread when sewing, in the plate-shaped members 30, 50 in advance is eliminated and, as such, the plate-shaped members 30, 50 can be provided with a simple configuration and manufacturing costs can be reduced.

In one example, the plate-shaped members 30, 50 can be easily molded by punching, with a circular die by pressing, flat plate-like polyamide 6 (PA6) having a thickness t of 0.5 mm. As such, manufacturing costs can be reduced.

When fixing the plate-shaped members 30 to the torso 20a, the plate-shaped members 30 are fixed to the torso 20a by the heads of the screws 40. Due to this, the plate-shaped members 30 can be firmly fixed to the torso 20a, and failures such as the exterior 10 detaching during operation of the robot 1 can be prevented from occurring. As such, a robot 1 can be realized that has improved ease of handling compared to conventional robots.

The plate-shaped members 30 are fixed by the screws 40 to the upper surface and both side surfaces of the back that are closer to the one end of the torso 20a, and the other end 30b of the plate-shaped members 30 is fixed to the inner surface of the exterior 10. When the line fastener 18 is open and the exterior 10 is pulled away, the entire exterior 10 does not separate from the main body because the exterior 10 is fixed to the torso 20a by the plate-shaped members 30. As such, a robot 1 can be realized that has improved ease of handling compared to conventional robots.

The label 300 and the power button 301 are exposed through the opening of the exterior 10 when the line fastener 18 is in the open state. Due to this, the label 300 can be confirmed and the power button 301 can be operated by opening the line fastener 18, and maintainability can be improved.

The present disclosure is not limited to the embodiment described above, and various modifications and uses are possible. In the embodiment described above, as an engager (the first engager) sewn to the exterior 10, plate-shaped members 30, 50 are used that are molded by circularly punching a polyamide 6 (PA6) plate. However, the material and shape of the engager can be selected as desired. For example, a configuration is possible in which a synthetic resin such as polycarbonate is used. Alternatively, a configuration is possible in which a member obtained by cutting a fabric made of chemical fibers such as polyester in a circular shape is used, a fabric made of natural fibers such as cotton or wool is used, or a sealing material made of rubber is used. Moreover, provided that the shape is a flat plate-like shape, the shape of the engager may have a polygonal shape such as a triangular shape or rectangular shape.

Additionally, a description is given in which the sewing position of the plate-shaped members 30 to the exterior 10 is the one end 30a of the plate-shaped member 30, as illustrated in FIG. 8, but other sewing positions may be used. The sewing position of the plate-shaped members 30 to the exterior 10 is set to a position that avoids the through-hole 31 of the plate-shaped members 30. Alternatively, a configuration is possible in which a circumferential sewing position is provided along the outer shape of the disk-shaped plate-shaped members 30.

The attaching of the plate-shaped members 30 to the exterior 10 is not limited to attaching by sewing using a sewing machine. For example, a configuration is possible in which the plate-shaped members 30 are sewn on by hand, or an adhesive is applied to the circumference of the round holes 50a and the plate-shaped members 30 are affixed. Note that, when sewing the through-holes 31 by hand, it is sufficient to form, in advance, holes in the plate-shaped members 30 for the needle to pass through. This facilitates the work of sewing by hand.

A description is given in which the thickness t of the plate-shaped members 30 is 0.5 mm, but the thickness can be changed provided that there are no problems with the sewing by the sewing machine. Additionally, as described above, when the attaching of the plate-shaped members 30 is carried out by sewing by hand or affixing by an adhesive, thickness limitations can be relaxed. For example, a thicker flat plate-like member may be used, or a member formed to have different thicknesses depending on location may be used as an engaging plate.

Three of the screw holes 21 for fixing the plate-shaped members 30 are provided in the torso 20a, but the number and the formation locations of the screw holes 21 can be determined as desired in accordance with the robot 1 to which the screw holes 21 are to be applied. For example, a configuration is possible in which two of the screw holes 21 are formed and two corresponding plate-shaped members 30 are provided. Moreover, a configuration is possible in which four or more of the screw holes 21 are formed and four or more corresponding plate-shaped members 30 are provided.

A description is given in which the robot 1 resembles a small animal, but what the robot 1 resembles can be determined as desired. For example, a configuration is possible in which the robot 1 resembles a large animal such as a rhinoceros. In such a case, the decoration part may resemble the horn of the rhinoceros.

The exterior 10 is not limited to a form that completely covers the main body 20, and a form is possible that covers a portion of the main body 20. A description is given in which the exterior 10 resembles the fur of a small animal, but what the exterior 10 resembles can be determined as desired. For example, a configuration is possible in which the exterior resembles clothing worn by the robot 1, or the exterior is a banner on which an advertisement is displayed.

A description is given in which the outer fabric 11 and the lining 12 are sewn together using the thread 13, but the outer fabric 11 and the lining 12 may be integrated using another method. For example, a configuration is possible in which an adhesive is used to adhere the outer fabric 11 to the lining 12.

In the present embodiment, a description is given in which the attachment member for fixing each of the plate-shaped members 30 to the main body 20 is the screw 40. Moreover, a description is given in which the attachment receiver to which the screw 40 is to be attached is the screw hole 21. However, the present disclosure is not limited thereto. A configuration is possible in which the attachment member is an engagement member other than the screw 40. Additionally, a configuration is possible in which the attachment receiver is an engagement receiver other than the screw hole 21. Furthermore a configuration is possible in which the attachment member is a member other than a member that is screwed into and engaged with the screw hole 21. For example, a configuration is possible in which the attachment member is double-sided tape, an adhesive, a member fixed by head welding, a member that is press-fitted, or a member that is hook fitted.

In the present embodiment, a description is given in which the other side attachment member for fixing each of the plate-shaped members 50 to the main body 20 is the protrusion-shaped part 60. Moreover, the other side attachment receiver to which the protrusion-shaped part 60 is to be attached is the insertion hole 22. However, the present disclosure is not limited thereto. A configuration is possible in which the other side attachment member is an engagement member other than the protrusion-shaped part 60. Additionally, a configuration is possible in which the other side attachment receiver is an engagement receiver other than the insertion hole 22. Furthermore a configuration is possible in which the other side attachment member is a member other than a member that is screwed into and engaged with the insertion hole 22.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A robot comprising:
an exterior;
a main body that is covered by the exterior and to which an attachment receiver is provided;
a fixing member that is provided on an inner surface of the exterior and at a position fixable to the attachment receiver, a through-hole being formed in the fixing member; and
an attachment member for fixing the fixing member to the main body by being attached to the attachment receiver, wherein
the attachment receiver is provided more toward one end of the main body, and
the fixing member includes a first end that is disposed in a non-fixed state to the inner surface of the exterior and a second end that is fixed to the inner surface of the exterior.

2. The robot according to claim 1, wherein, in the fixing member, the through-hole is formed between the first end that is disposed in the non-fixed state to the inner surface of the exterior and the second end fixed to the inner surface of the exterior.

3. The robot according to claim 1, wherein the attachment receiver is provided such that the attachment member attached to the attachment receiver is exposed upon removal of a portion of the exterior from the main body.

4. The robot according to claim 3, wherein the exterior includes an opening that is provided with an openable/closeable fastener and that exposes the one end of the main body and the attachment member attached to the attachment receiver.

5. The robot according to claim 1, wherein the second end of the fixing member is fixed to the inner surface of the exterior by being sewn to the inner surface of the exterior.

6. The robot according to claim 1, wherein the fixing member is fixed such that the attachment member is exposed upon removal of the exterior on one end.

7. The robot according to claim 1, wherein
the attachment member is a screw,
the attachment receiver is a screw hole into which the screw is screwed into to engage, and
the screw fixes the fixing member to the main body by being inserted into the through-hole formed in the fixing member and then being screwed into the screw hole.

8. The robot according to claim 1, wherein
the main body is provided with an other side attachment receiver nearer to an other end on a side opposite the one end,
the robot further comprises
an other side fixing member that is provided on an inner surface of the exterior and at a position fixable to the other side attachment receiver, an other side through-hole being formed in the other side fixing member, and
an other side attachment member for fixing the other side fixing member to the main body by being attached to the other side attachment receiver and a head being inserted into the other side through-hole, and
the other side attachment receiver is provided nearer to the other end on the side opposite the one end of the main body.

9. A manufacturing method for the robot according to claim 1, the method comprising:
forming the fixing member from resin and in a flat plate shape having a predetermined thickness, and so as to include the through-hole through which the attachment member can be inserted;
sewing the formed fixing member to a lining of the sheet-like exterior while passing a needle of a sewing machine through at a portion other than the through-hole of the fixing member;
after turning the lining of the exterior outward, covering the main body with the exterior while turning an outer fabric of the exterior outward; and
attaching the attachment member to the attachment receiver provided on the main body in a state in which the exterior is covering the main body.
